(19) United States
(12) Patent Application Publication
(10) Pub. No.: US 2013/0241489 A1
(43) Pub. Date: Sep. 19, 2013

(54) Cell Phone Docking Charger

(71) Applicant: Shao-Chieh Ting, New Taipei City (TW)

(72) Inventor: Shao-Chieh Ting, New Taipei City (TW)

(21) Appl. No.: 13/422,367

(22) Filed: Mar. 16, 2012

(51) Int. Cl. H02J 7/00

(52) U.S. Cl. 320/111

(57) ABSTRACT

The present invention discloses a cell phone docking charge that is used on a wall receptacle. To improve an existing cell phone docking charger that requires a transmission line, a cell phone recharge connector and a charging unit of the present invention are combined. The recharge connector and an AC plug are rotatable separately and can be rotated out for containing, so as to facilitate carrying by a user. The recharge connector is equipped with plural types and can be rotated open at various angles.

### BACKGROUND OF THE INVENTION

a) Field of the Invention

The present invention relates to a cell phone docking charger, and more particularly to a cell phone docking charger that is used on a wall receptacle without utilizing a transmission line. An AC (Alternating Current) plug and a recharge connector of the docking charger are rotatable separately to facilitate containing and carrying. The AC plug can rotate bi-directionally so that the AC plug can be applied to holes of the wall receptacle of various orientations. The recharge connector can be rotated open at various angles to fulfill that when cell phones of different lengths are recharged, the cell phones can all be leaned against on the wall. Besides, the recharge connector is equipped with plural types, so that the recharge connector can be applied to the cell phones of various types of connectors.

b) Description of the Prior Art

There are a lot of cell phone chargers sold on existing markets. Just for a docking charger, a transmission line will be required when the docking charger is used. However, the transmission line is often out of order, and thus, it is inconvenient when the docking charger is contained or carried by a user.

Accordingly, to solve the abovementioned problems, a cell phone docking charger that is used on a wall receptacle without utilizing a transmission line is provided by the present inventor.

### SUMMARY OF THE INVENTION

The primary object of the present invention is to provide a cell phone docking charger that is used on a wall receptacle without utilizing a transmission line. The docking charger includes primarily a charging unit, an AC plug, a rotary disk and a recharge connector. The AC plug and the recharge connector are all opened and closed by rotation, so that the user can contain and carry the docking charger conveniently.

A second object of the present invention is to provide a cell phone docking charger that is used on a wall receptacle without utilizing a transmission line, wherein the AC plug can rotate bi-directionally that the AC plug can be applied to holes of the wall receptacle of various orientations.

A third object of the present invention is to provide a cell phone docking charger that is used on a wall receptacle without utilizing a transmission line, wherein the recharge connector can be rotated by plural angles, enabling the cell phones of various lengths to be leaned against on the wall for recharging.

A fourth object of the present invention is to provide a cell phone docking charger that is used on a wall receptacle without utilizing a transmission line, wherein the recharge connector is equipped with plural types to be compatible with the cell phones of various types of connectors.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a three-dimensional schematic view of a cell phone docking charger of the present invention, with that an AC plug and a recharge connector are rotated open.

FIG. 2 shows a three-dimensional schematic view of the cell phone docking charger of the present invention, with that the AC plug and the recharge connector are contained.

FIG. 3 shows a three-dimensional exploded view of the cell phone docking charger of the present invention.

FIG. 4 shows a three-dimensional schematic view of the cell phone docking charger of the present invention, with that the AC plug is rotated left by 90 degrees.

FIG. 5 shows a three-dimensional schematic view of the cell phone docking charger of the present invention, with that the AC plug is rotated right by 90 degrees.

FIG. 6 shows a schematic view of another embodiment of the recharge connector of the cell phone docking charger, according to the present invention.

FIG. 7 shows a side view of the cell phone docking charger that is used for a short cell phone, according to the present invention.

FIG. 8 shows a side view of the cell phone docking charger that is used for a medium-long cell phone, according to the present invention.

### DETAILED DESCRIPTION OF THE PREFERRED EMBODIMENTS

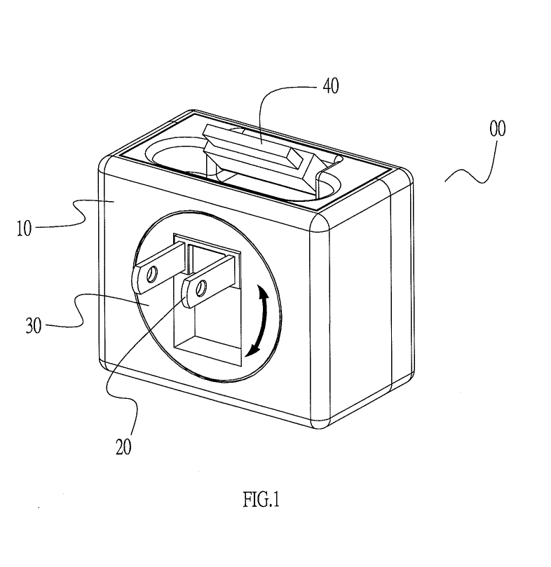

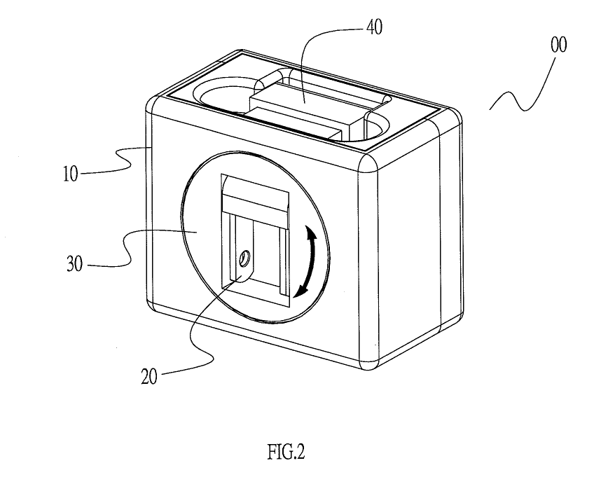

Referring to FIG. 1 and FIG. 2, it shows three-dimensional schematic views of a cell phone docking charger of the present invention. As shown in the drawings, the cell phone docking charger 00 of the present invention comprises a charging unit 10, a 2-pin AC plug 20, a rotary disk 30 and a recharge connector 40.

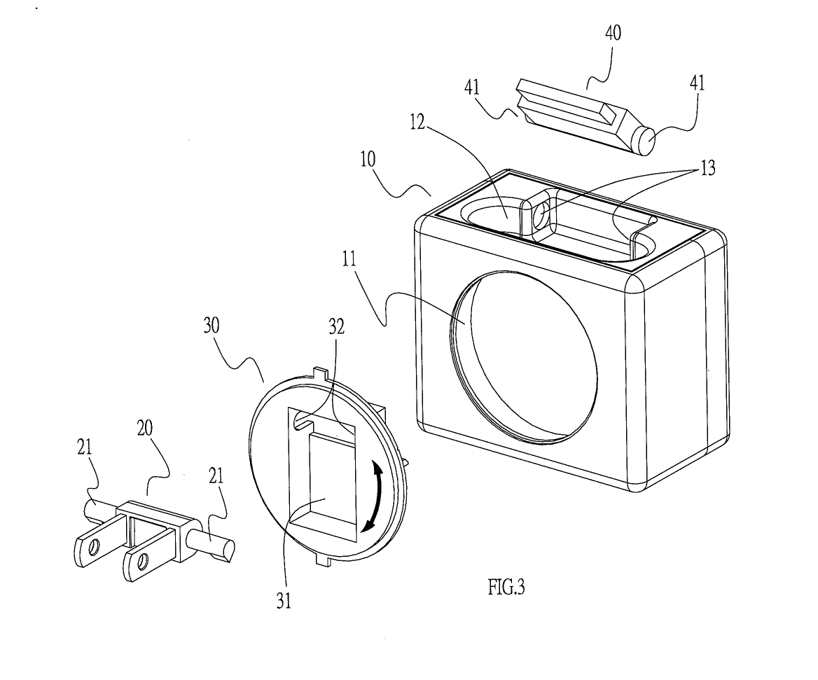

Referring to FIG. 3 at a same time, it shows a three-dimensional exploded view of the cell phone docking charger of the present invention, wherein the charging unit 10 is the core of the charger and is used to emplace all kinds of electronic elements. The charging unit 10 is provided with the rotary disk 30, a fixing groove 11 for containing the rotary disk 30, and the recharge connector 40, as well as a containing slot 12 and two shaft holes 13 of the recharge connector 40. The shaft holes 13 are tightly sheathed with pivots 41 that are provided on the recharge connector 40, allowing the recharge connector 40 to rotate by various angles.

The AC plug 20 is the input end of the charger and two sides of the AC plug 20 are provided with a pivot 21 respectively. The pivots 21 are sheathed with shaft holes 32 that are provided on the rotary disk 30, so that the rotary disk 30 can be rotated for containing, thereby reducing the size of the charger to facilitate carrying.

The rotary disk 30 is provided at a side of the charging unit 10 to emplace the AC plug 20 and the angle of the AC plug 20 can be adjusted according to the orientations of holes of the wall receptacle. The rotary disk 30 is provided with a containing slot 31 to contain the AC plug 20, and two sides of the containing slot 31 are provided with a shaft hole 32 respectively. The shaft holes 32 are sheathed with the pivots 21 that are provided on the AC plug 20, enabling the AC plug 20 to rotate for containing.

The recharge connector 40 is the output end of the charger, and two sides of the recharge connector 40 are provided with the pivot 41, respectively. The pivots 41 are sheathed with the shaft holes 13 that are provided on the charging unit 10, so that the recharge connector 40 can be opened and closed by rotation and can be used to connect to a cell phone for recharging. In addition, the recharge connector 40 can be adjusted to plural angles according to the length or width of the cell phone.

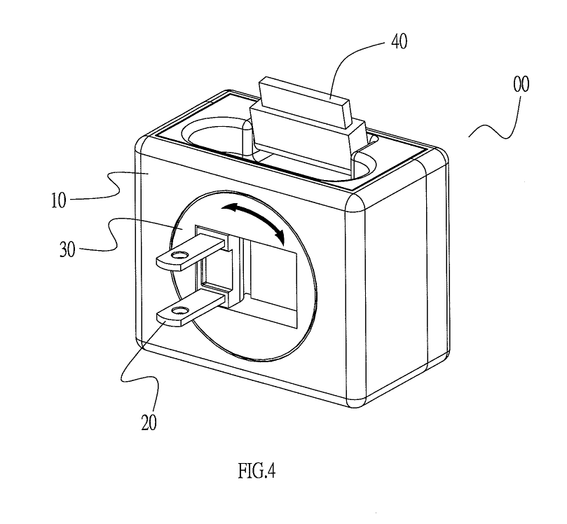

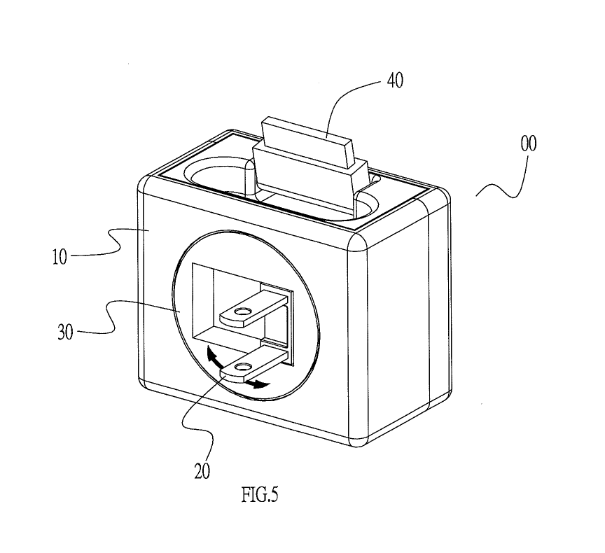

Referring to FIG. 4 and FIG. 5, it shows three-dimensional schematic views of the cell phone docking charger 00 of the present invention, with that the AC plug 20 rotates bi-directionally, e.g. left and right by 90 degrees.

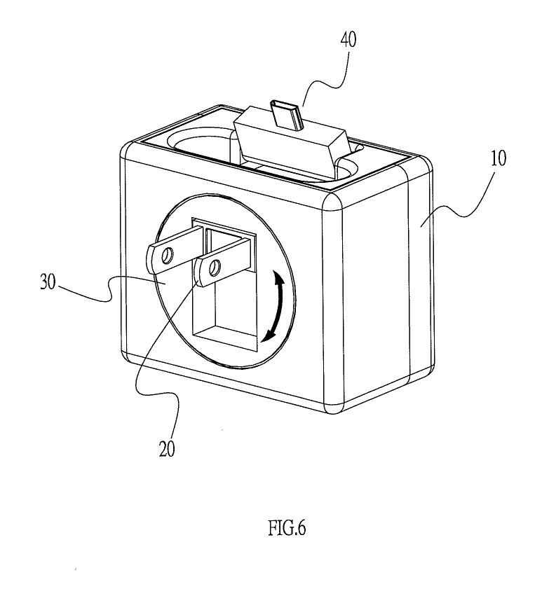

Referring to FIG. 6, it shows a three-dimensional schematic view of another embodiment of the recharge connector of the cell phone docking charger, according to the present invention. As shown in the drawing, the recharge connector 40 can be further a Mini USB (Universal Serial Bus) or a Micro USB connector that is often used as the recharge connector of the cell phone.

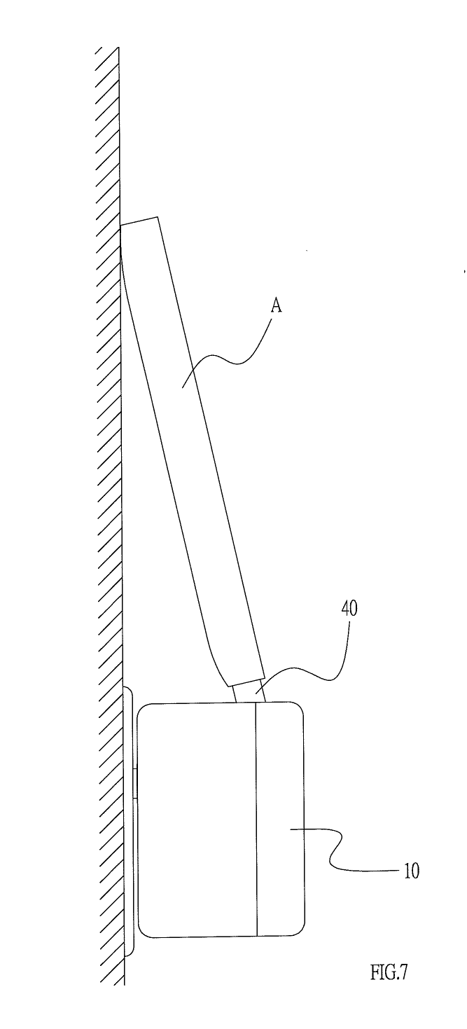

Referring to FIG. 7, it shows a schematic view of the present invention that is used to recharge a short cell phone A, wherein the recharge connector 40 is adjusted to a proper angle, enabling the short cell phone A to be leaned against on a wall for recharging.

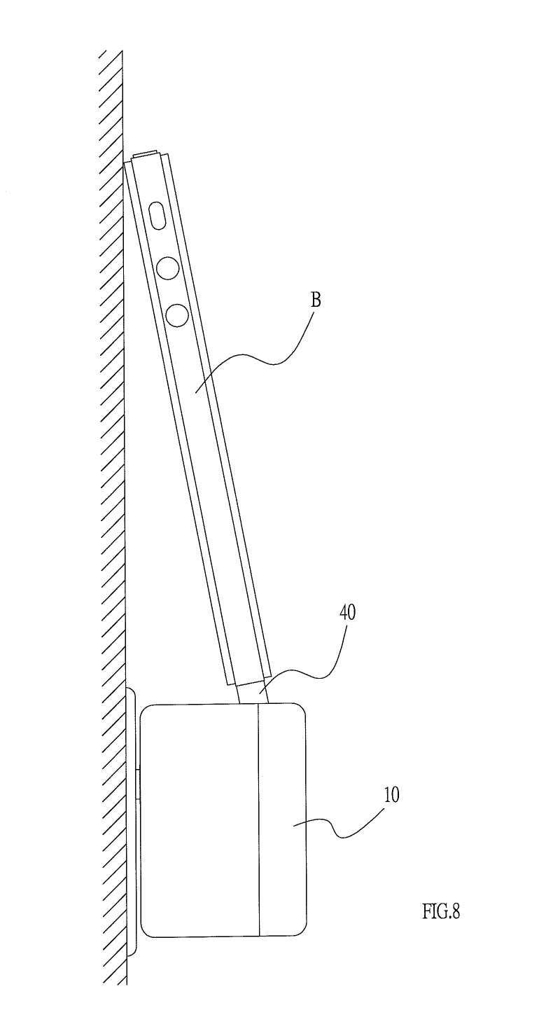

Referring to FIG. 8, it shows a schematic view of the present invention that is used to recharge a medium-long cell phone B, wherein the recharge connector 40 is adjusted to a proper angle, enabling the medium-long cell phone B to be leaned against on a wall for recharging.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A cell phone docking charger comprising:
a charging unit, being a core of the charger to emplace all kinds of electronic elements, and is provided with a rotary disk, a fixing groove for emplacing the rotary disk, a recharge connector and a containing slot of the recharge connector;
an AC (Alternating Current) plug, being an input end of the charger and two sides of the AC plug are provided respectively with a pivot to be sheathed with a shaft hole on the rotary disk;
the rotary disk, the rotary disk is provided at a side of the charging unit to contain the AC plug and to allow the AC plug to rotate left and right by 90 degrees respectively; and
the recharge connector, is provided at a side of the charging unit, is an output end of the charger and is used to connect to a cell phone for recharging.

2. The cell phone docking charger according to claim 1, wherein the AC plug rotates bi-directionally.

3. The cell phone docking charger according to claim 1, wherein the recharge connector is opened and closed by rotation at plural angles.

4. The cell phone docking charger according to claim 1, wherein the recharge connector is equipped with plural types.
